(19) United States
(12) Patent Application Publication
(10) Pub. No.: US 2026/0037002 A1
(43) Pub. Date: Feb. 5, 2026

(54) AUTONOMOUS FORKLIFT TRUCK FOR LIFTING AND TRANSPORTING A LOAD, AND ASSOCIATED METHOD

(71) Applicant: COMPAGNIE GENERALE DES ETABLISSEMENTS MICHELIN, Clermont-Ferrand (FR)

(72) Inventors: YANN BINDA, Clermont-Ferrand (FR); FLORIAN FAURE, Clermont-Ferrand (FR); KEVIN BOUVET, Clermont-Ferrand (FR)

(21) Appl. No.: 18/997,256

(22) PCT Filed: Jun. 14, 2023
(86) PCT No.: PCT/FR2023/050864

§ 371 Date: Jan. 21, 2025

(30) Foreign Application Priority Data
Jul. 21, 2022 (FR) 2207492

(51) Int. Cl. G05D 1/667; B66F 9/06; B66F 9/075; G01B 11/06; G01S 17/931; G05D 105/28

(52) U.S. Cl. CPC G05D 1/667; B66F 9/063; B66F 9/0755; G01B 11/0608; G01S 17/931; G05D 2105/28

(57) ABSTRACT

This autonomous forklift truck (1) comprises: a lifting member (2) comprising a vertically mobile fork (4) provided with at least one arm (4a, 4b) for lifting loads, a drive system (6) for moving the truck (1), and a control unit (14) able to control the operation of the drive system (6) for autonomous guidance of the truck and able to control the vertical movement of the fork (4). The truck further comprises a device (8) for contactless detection of an obstacle mobile conjointly with the lifting member (2). The detection device (8) is able to emit a light beam sweeping at least one predefined plane detection zone to detect the presence or the absence of an obstacle. The detection device (8) is fixed to the lifting member so that the light beam passes above the transported load.

### TECHNICAL FIELD

The present invention concerns the field of autonomous vehicles for the automated transportation of loads, such as autonomous forklift trucks.

### PRIOR ART

Autonomous vehicles for transporting loads are increasingly used to increase productivity and to improve logistical management in manufacturing plants and warehouses.

Automated forklift trucks are such vehicles, for example, and enable loading, transportation and positioning at height of a load without human intervention.

However, in environments such as manufacturing plants or warehouses human intervention remains necessary to complement automated operations, for example to check that those operations are carried out correctly or to carry out tasks that cannot be effected by machines alone. These environments are therefore shared between humans and autonomous machines.

The safety of persons is fundamental in such working environments and consequently requires specific procedures to be implemented.

For example, during operations of placing a load on storage shelving it is necessary to check that the location in the shelving intended to receive the load is empty.

To this end forklift trucks are classically provided with rangefinders or photoelectric cells.

However, these technologies do not make it possible to detect all types of load that may be present on the storage shelving. This is the case for example if the load comprises holes or bores, as is the case for tires in particular.

### STATEMENT OF THE INVENTION

Given the above, the aim of the invention is therefore to propose an autonomous forklift truck able to detect remotely and contactlessly loads already disposed on storage shelving with highly reliable detection whatever the size or the shape of the loads to be detected.

The invention has for object an autonomous forklift truck comprising a lifting member comprising a fork mobile vertically and provided with at least one arm for lifting loads, a drive system for moving the forklift truck, a control unit able to control the operation of the drive system to guide the forklift truck autonomously and able to control the vertical movement of the fork of the lifting member.

In accordance with one general feature the forklift truck further comprises a device for contactless detection of an obstacle, said detection device being mobile conjointly with the lifting member and able to emit a light beam directed toward the front of the forklift truck and sweeping at least one predefined plane detection zone. The detection device is fixed to the lifting member so that said light beam passes above the transported load.

The light beam passing above the transported load, the presence of the load therefore does not impede the detection effected by the detection device.

In accordance with another general feature the forklift truck further comprises a measuring device for determining the height of the fork of the lifting member relative to the ground.

In accordance with another general feature the control unit receives information representing the height of the fork relative to the ground coming from the measuring device and the presence or the absence of an obstacle in said predefined plane detection zone coming from the contactless detection device.

In accordance with another general feature the control unit is able to control the drive system and the vertical movement of the fork of the lifting member as a function of that information.

With such an autonomous forklift truck it becomes possible, when depositing a load on storage shelving, to check that the place on the shelving intended to receive that load is free of any other load that could constitute an obstacle to depositing it and that the forklift truck can move forward without risk of pushing on a load already present and therefore causing it to fall.

Furthermore, the integration of such a contactless detection device makes it possible to detect any type of load remotely.

The detection device is advantageously fixed above a carriage of the lifting member supporting the fork.

The carriage of the lifting member preferably comprises an upper crossmember to which the detection device is fixed.

The height of the fork of the lifting member relative to the ground is preferably determined continuously. This continuous measurement further increases the reliability of the forklift truck.

In accordance with another feature the forklift truck further comprises a means for determination of a rectilinear movement of the forklift truck. The determination means is able to acquire information representing the movement of the forklift truck.

In accordance with another feature the control unit receives information representing the movement of the forklift truck coming from the determination means and is able to control the operation of the drive system as a function of that information.

In one particular embodiment the determination means comprises an all-or-nothing sensor oriented perpendicularly to a wheel of the forklift truck and coupled to the chassis of said truck and an indicator placed on a steering rod of said wheel, the all-or-nothing sensor being able to detect the indicator. Detection of the indicator corresponds to an orientation of the wheels according to a longitudinal axis of the forklift truck. The determination means also comprises a device for measuring the movement of the forklift truck, said device for measuring the movement of the forklift truck being adapted to acquire information representing the movement of the forklift truck.

In another particular embodiment the determination means comprises a direction sensor oriented perpendicularly to a wheel of the forklift truck and coupled to the chassis of said truck and a magnetized target fixed onto a steering rod of said wheel. The sensor is able to detect the position of the magnetized target as a function of the steering angle of said wheel. The determination means also comprises a device for measuring the movement of the forklift truck, said device for measuring the movement of the forklift truck being able to acquire information representing the movement of the forklift truck.

As seen from the side of the forklift truck, the light beam emitted by the detection device advantageously forms with a horizontal axis an angle of inclination.

Alternatively the light beam emitted by the detection device could be horizontal.

The light beam emitted by the detection device is preferably directed downwards.

Alternatively the light beam emitted by the detection device could be directed upwards.

In accordance with one feature the predefined plane detection zone swept by the light beam emitted by the contactless detection device is defined by four points delimiting a rectangle.

The autonomous forklift truck comprises an onboard location device configured to acquire forklift truck position data and communicating with the control unit. The contactless detection device is preferably separate from the location device. The means for determining the rectilinear movement are preferably also separate from the location device.

In accordance with another aspect the invention has for object a method of transporting and depositing a load by means of an autonomous forklift truck as described hereinabove.

The transportation and deposition method comprises:
a step of positioning the forklift truck relative to a structure intended to support the load in an approach position relative to said structure,
when the forklift truck has reached the approach position a step of heightwise positioning of the fork of the lifting member and a step of obstacle detection by the contactless detection device in a control volume swept by the light beam,
a step of forward movement of the forklift truck relative to the structure to a deposition position if no obstacle has been detected in the control volume by the contactless detection device during the step of obstacle detection, and
a step of depositing the load on the structure at the deposition position.

The obstacle detection step advantageously comprises:
a substep of activation of the detection device when the fork of the lifting member has reached a predetermined first height relative to the ground during heightwise positioning of the fork, and
a substep of deactivation of the detection device when the fork of the lifting member has reached a second height relative to the ground that is different from the predetermined first height.

The method advantageously comprises a step of controlling the rectilinear movement of the forklift truck to the deposition position during the forward movement step.

The step of depositing the load on the structure in the deposition position is advantageously carried out if the controlled movement of the forklift truck is purely rectilinear or substantially rectilinear.

By “substantially rectilinear” is meant that the movement of the forklift truck includes transverse variations relative to a purely rectilinear movement that remain less than or equal to a predetermined limit value.

### BRIEF DESCRIPTION OF THE FIGURES

Other aims, features and advantages of the invention will become apparent on reading the following description given by way of non-limiting example only and with reference to the appended drawings, in which:

FIG. 1 is a perspective view of an autonomous forklift truck in accordance with one embodiment of the invention;

FIG. 2 to FIG. 4, FIG. 6, FIG. 7 and FIG. 8 schematically depict the forklift truck from FIG. 1 in use;

FIG. 5 is a partial view from above of the forklift truck from FIG. 1 on which is schematically represented a first load detection zone; and

FIG. 9 is the flowchart of a transportation and deposition method in accordance with one embodiment of the invention.

### DETAILED DESCRIPTION OF AT LEAST ONE EMBODIMENT

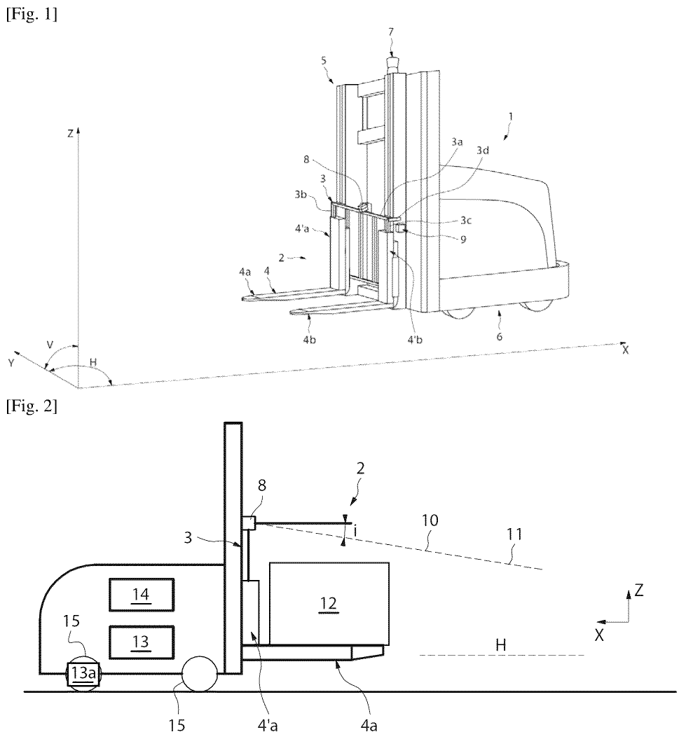

In FIG. 1 there have been represented the main elements of an autonomous forklift truck 1 in accordance with one embodiment of the invention.

The architecture of the forklift truck 1 is described by way of example and does not limit the invention to the only configuration of the architecture described. It is understood that the invention also concerns forklift trucks designed to operate in manual mode that have been adapted to enable an autonomous second operating mode.

The autonomous forklift truck 1 depicted in FIG. 1 comprises a lifting member 2 comprising a carriage 3 that supports a fork 4 comprising two arms 4a, 4b spaced laterally and extending toward the front of the truck. Alternatively the fork 4 could comprise only one arm.

The carriage 3 forms a frame. The carriage 3 is provided with a horizontal upper crossmember 3a and two arms 3b, 3c extending the upper crossmember 3a vertically downwards.

The fork 4 also comprises two uprights 4′a, 4′b that are fixed to the carriage 3 and each of which supports one of the arms 4a, 4b. Each of the uprights 4′a, 4′b is fixed on one of the arms 3b, 3c of the carriage.

The arms 4a, 4b of the fork are generally used by being inserted in insertion tunnels provided in transportation pallets supporting the loads to be lifted. The uprights 4′a, 4′b enable lifting of the arms 4a, 4b in order to be able to lift a transport pallet or some other type of load and to be able to put down or to pick up a pallet or other type of load at height.

The fork 4 is able to move in translation in a vertical plane V defined by the carriage 3 along a vertical mast 5 of the truck. The uprights 4′a, 4′b are able to slide along the mast 5. The arms 4a, 4b of the fork are mobile between a high end position and a low end position depicted in FIG. 1 and correspond to a rolling position. In the lower end position the arms 4a, 4b are situated at a distance from the ground.

The longitudinal axes of the arms 4a, 4b are parallel. These longitudinal axes are oriented parallel to a horizontal axis X and define a horizontal plane H known as the lifting plane. The arms 4a, 4b of the fork 4 are perpendicular to the vertical plane V. The arms 4a, 4b of the fork 4 are also preferably movable laterally relative to one another.

Alternatively the arms 4a, 4b could also be telescopic or retractable and/or angularly orientable around a longitudinal axis.

In a manner that is known in itself the truck 1 is equipped with a drive system 6 enabling movement of the truck 1. The drive system comprises at least one electric motor or internal combustion engine (not represented) for driving the wheels 15 of the truck 1.

The truck 1 is also equipped with an onboard location device 7 and an onboard control unit 14 (FIG. 2) receiving information from the location device 7 for autonomous control of the movement of the forklift truck.

The control unit 14 comprises hardware and software means for controlling the operation of the drive system 6 as a function of information received from the location device 7. The control unit 14 is also used to control autonomous movement of the lifting member 2.

The truck 1 is also equipped with a contactless detection device 8 that is mobile conjointly with the lifting member 2 and a measuring device 9 for determining the height of the fork 4 relative to the ground. Data from the detection device 8 and the measuring device 9 is transmitted to the control unit 14. The detection device 8 and the measuring device 9 are separate from the location device 7.

The device 9 measures continuously the relative height between the mast 5 and the carriage 3. In the embodiment depicted the measuring device 9 is fixed to the mast 5 of the forklift truck and oriented toward a target 3d fixed to the carriage 3. The measuring device 9 is fixed to the mast 5 at a constant height relative to the ground. The measuring device 9 is configured to measure the relative height between the mast 5 and the carriage 3. The control unit 14 determines the height of the fork from the measured relative height between the mast 5 and the carriage 3 by subtracting the value of a predetermined constant offset parameter that corresponds to the relative height between the mast 5 and the carriage 3 when the fork 4 is situated at the lowest position. When the fork 4 is situated at the lowest position the value thus determined of the fork 4 is therefore equal to zero. For example, the measuring device 9 may comprise a rangefinder or a redundant combination of two rangefinders for determining the height of the fork 4 relative to the ground.

Alternatively the height of the fork 4 relative to the ground could be determined directly at the level of the measuring device 9 by subtracting the value of said offset constant parameter from the measured value of the relative height between the mast 5 and the carriage 3.

As indicated above, in the embodiment depicted the measuring device 9 is fixed to the mast 5 at a constant height relative to the ground. Alternatively the measuring device 9 could be fixed at a constant height relative to the ground on a component of the truck other than the mast 5. Alternatively it is equally possible for the measuring device 9 to be mobile conjointly with the lifting member 2, for example by being fixed to the carriage 3 of the lifting member, in particular fixed to one of the arms of the carriage 3.

The detection device 8 is fixed to the carriage 3 with no possibility of movement relative to said carriage. Here the detection device 8 is fixed to the upper crossmember 3a of the carriage.

As described in more detail hereinafter the contactless detection device 8 is able to emit a light beam 10 (FIG. 2) directed toward the front of the forklift truck 1, passing over the transported load 12 and sweeping a plane detection zone 11 to detect the presence or the absence of an obstacle.

The detection device 8 is fixed to the carriage 3 of the lifting member so that the light beam 10 passes above any type of load that can be transported by the forklift truck in the considered application of the truck.

In the example depicted the light beam 10 emitted by the detection device 8 is inclined downwards. As seen from the side of the forklift truck the light beam 10 emitted by the detection device 8 therefore forms with a horizontal axis an inclination angle i.

In operation the detection device 8 is configured to detect if an obstacle is located inside the detection zone 11. The obstacle is detected by the device 8 when it intersects the light beam 10 and is located inside the detection zone 11. The detection device 8 is able to detect that the obstacle is located inside the detection zone 11 by a measurement of distance and of angle.

If the light beam 10 emitted by the device 8 is not intercepted by the obstacle or if there is such interception but the detection device 8 detects that the distance separating it from the obstacle is outside the predefined plane detection zone 11 then the device 8 detects an absence of obstacles in said detection zone.

The truck 1 is also equipped with a means 13 (FIG. 2) for determination of a rectilinear movement of the forklift truck relative to the ground, said determination means 13 being able to acquire information representing the rectilinear movement of the forklift truck over the ground. The determination means is distinct from the location device 7.

The determination means 13 comprises a device 13a for measuring the movement of the forklift truck 1, said measuring device 13a being configured to acquire information representing the movement of the truck 1 and to transmit it to a control unit 14.

The measuring device 13a preferably comprises at least one rotary encoder able to measure the rotation of at least one of the wheels 15 of the forklift truck 1. The encoder is able to determine the value of the movement of the forklift truck 1 as a function of the detected number of turns of the associated wheel 15.

The determination means 13 also comprises a steering sensor oriented perpendicularly to a wheel 15 of the forklift truck and coupled to the chassis of the truck and a magnetized target fixed to a steering rod of the wheel 15 of the forklift truck. The sensor is able to detect the position of the magnetized target that is a function of the steering angle of that wheel 15 corresponding to the steering angle of the movement of the forklift truck.

The rectilinear movement of the forklift truck 1 is controlled on the basis of information from the measuring device 13a and the steering sensor, acquired at a predetermined frequency. For example, the frequency of acquisition of information for controlling the rectilinear movement of the forklift truck 1 may be 10 milliseconds. The purely rectilinear or substantially rectilinear movement of the forklift truck 1 is controlled in accordance with the following equation:

$$\vert \sum ( angle \times distance ) \vert \leq K \qquad ( 1 )$$

in which,
angle represents the steering angle of the movement of the forklift truck relative to its longitudinal axis measured at a given time by the steering sensor, expressed in degrees;
distance represents the distance travelled by the forklift truck measured by the measuring device 13a between two acquisitions, expressed in millimeters;
∥ is the absolute value of the calculated sum; and
K represents a predetermined limit value corresponding to a maximum admissible transverse movement of the forklift truck.

As indicated above the control unit 14 receives information coming from the location device 7 and information representing the height of the fork coming from the measuring device 9 and information representing the presence or the absence of an obstacle in the detection zone concerned coming from the detection device 8. The control unit 14 also receives information representing the rectilinear movement coming from the determination means 13.

The control unit 14 controls the operation of the drive system 6 and the vertical movement of the fork 4 as a function of this information.

In the embodiment described the determination means 13 comprises a steering sensor and a magnetized target that may for example be a magnetostrictive rule. In an alternative embodiment the determination means 13 could comprise an all-or-nothing sensor oriented perpendicularly to a wheel 15 of the forklift truck and coupled to the chassis of the truck 1. In this case the determination means 13 also comprises an indicator placed on the steering rod of the wheel 15. The all-or-nothing sensor is able to detect the indicator, what is detected corresponding to an orientation of the wheel 15 with respect to a longitudinal axis of the truck 1. The indicator may comprise an RF ID type tag, for example.

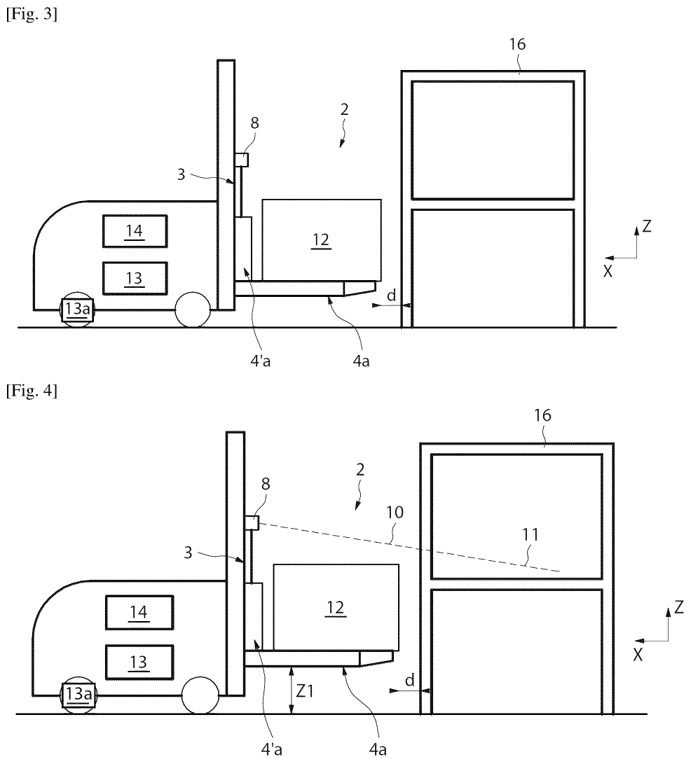

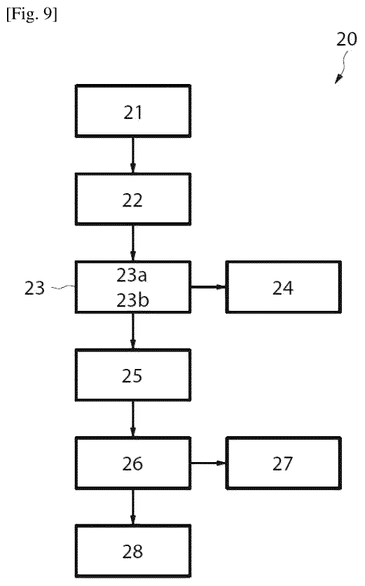

There will now be described with reference to FIGS. 3 to 8 the operating principle of the autonomous forklift truck 1 for the operation of depositing a load 12 safely on a shelving type structure 16 intended to receive the load 12 transported by the truck and the associated deposition method 20 depicted in FIG. 9.

The method 20 commences with a positioning step 21 during which the control unit 14 controls the forklift truck 1 to position it relative to the shelving 16 in a predefined approach position. In one particular embodiment the position of the forklift truck 1 in the approach position may be stored by the control unit 14.

In this initial phase depicted in FIG. 3 the control unit 14 controls the operation of the truck 1 to move it toward the shelving 16. The truck 1 is controlled by the control unit 14 as a function of data coming from the location device 7. As it moves the truck 1 is controlled to maintain a minimum safety distance d from the shelving 16. During the initial phase of positioning the forklift truck and the successive phases of heightwise positioning of the arms of the fork 4 the truck 1 is controlled to maintain this minimum horizontal safety distance d between the overhanging ends of the arms of the fork 4 and the shelving 16 in order to enable safe heightwise positioning of the arms.

When the truck 1 reaches the approach position the method 20 continues with a step 22 of heightwise positioning of the fork 4 during which the control unit 14 controls the vertical movement of the arms 4a, 4b between a first height Z1 and a second height Z2 relative to the ground.

The control unit 14 controls the vertical positioning of the arms 4a, 4b until the first height Z1 relative to the ground is reached (FIG. 4), as a function of data coming from the measuring device 9. The value of the height Z1 is predetermined. For example, the value of the height Z1 may depend on data such as the dimensions of the shelving 16 and of the load 12 to be deposited, the positioning of the detection device 8 relative to the arms 4a, 4b and the inclination i of the light beam 10 that can be emitted by the detection device 8.

When the arms of the fork 4 have reached the height Z1 the method continues with a step 23 of obstacle detection. This step 23 comprises an activation substep 23a in which the control unit 14 controls the activation of the contactless detection device 8, which emits the light beam 10 when the fork 4 has reached the height Z1, and a deactivation substep 23b during which the control unit 14 controls deactivation of the contactless detection device 8 when the arms of the fork 4 have reached the second height Z2 (FIG. 6) different from the first height Z1.

Thus the obstacle detection step 23 is carried out during the step 22 of heightwise positioning of the fork 4. The vertical movement of the arms 4a, 4b during this step 22 is continuous.

The value of the height Z2 may be predetermined and may depend on the same data as that used to determine the value of the height Z1. When the value of the height Z2 is predetermined the control unit 14 controls the vertical positioning of the arms of the fork 4 until this height Z2 is reached as a function of data coming from the measuring device 9.

Alternatively the value of the height Z2 may be determined as a function of a time-delay that is triggered starting at the first height Z1.

During the activation substep 23a the light beam 10 emitted by the detection device 8 sweeps a plane predefined detection zone 11. The detection device 8 continues to be activated until the arms 4a, 4b reach the height Z2.

The width and the height of the vertical projection of the detection zone 11 do not exceed the width and the depth of the shelving 16.

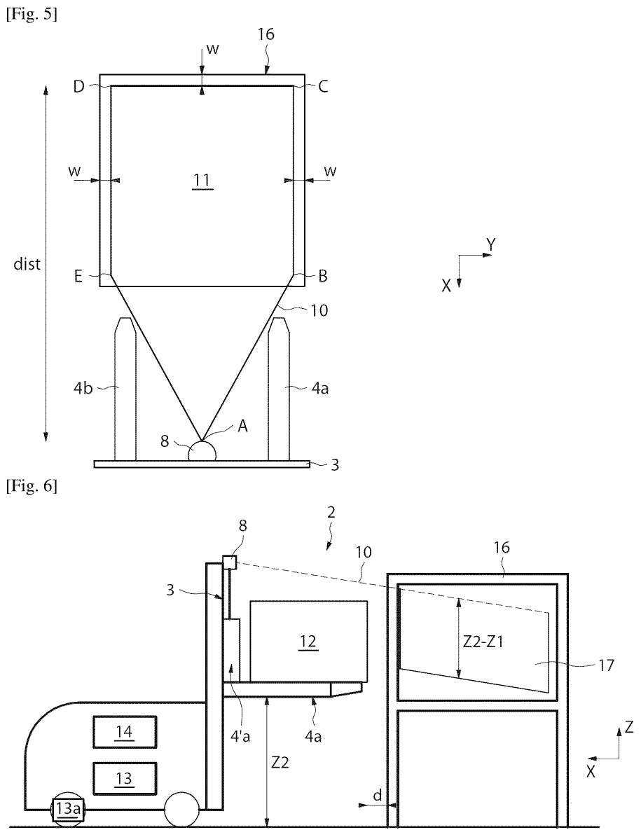

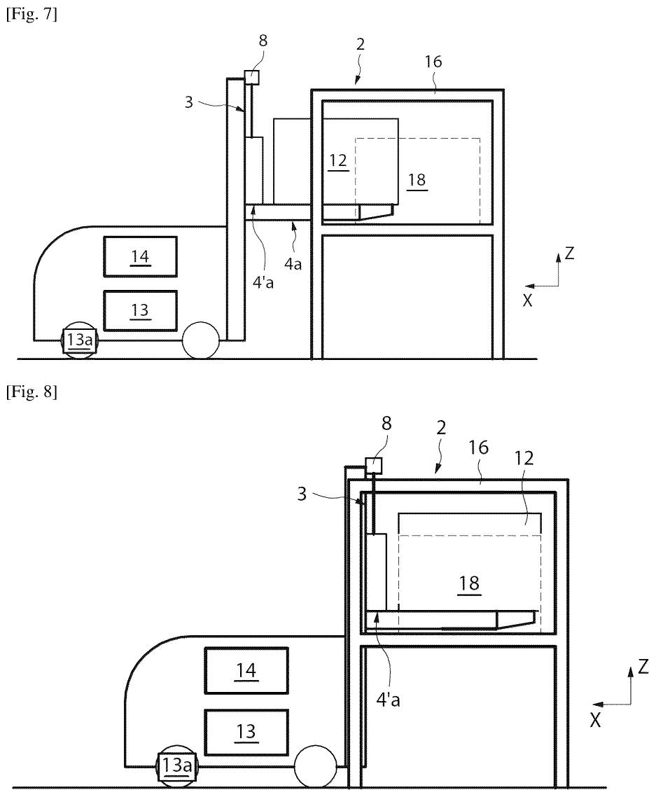

In the embodiment depicted the detection zone 11 is defined by four distinct points delimiting a rectangle, such as the points B, C, D and E in FIG. 5. The point A schematically represents the point of emission of the light beam 10 from the output of the detection device 8.

The vertical projection of the rectangle delimited by the points B, C, D and E is situated at a minimum distance w from the interior edges of the shelving 16, thus constituting a safety margin against unwanted detection of said edges of the shelving 16. For example, the distance w may be equal to 100 mm.

As indicated above the detection device 8 is active during the vertical movement between the height Z1 and the height Z2 and emits the light beam 10 to detect any obstacle present in the detection zone 11. Given that the detection device 8 effects a vertical movement between the heights Z1 and Z2 it follows that the light beam 10 is swept over all the height interval between Z1 and Z2 and that obstacle detection is effected within a control volume 17 (FIG. 6) the height of which is equal to the vertical movement between the heights Z1 and Z2 and the cross section of which is equal to the detection zone 11.

If an obstacle is detected in the control volume 17 during the obstacle detection step 23 the control unit 14 stops the truck 1 for resetting by an operator (step 24).

On the contrary, if no obstacle has been detected the method continues with a step 25 of forward movement of the forklift truck 1 during which the control unit 14 controls rectilinear movement of the truck from the approach position to a predetermined position 18 for deposition on the shelving 16 (FIG. 7). The determination means 13 acquire information representing the movement of the forklift truck during the forward movement. As indicated above this information is acquired at a predetermined frequency.

In one particular embodiment, during the step 25 of forward movement of the forklift truck 1 the method continues with a control step 26 during which the control unit 14 controls the rectilinear movement of the truck as a function of data coming from the determination means 13 until the deposition position 18 is reached longitudinally. At this stage the load 12 is situated vertically above the deposition position 18. For safety reasons, this ensures that any transverse deviations of the forklift truck 1 relative to the rectilinear movement remain less than the predetermined permissible limit value.

If movement of the forklift truck 1 is not determined as being rectilinear or substantially rectilinear by the determination means 13 the control unit 14 stops the truck 1 for resetting by an operator (step 27).

In the contrary case the control unit 14 controls the rectilinear movement of the truck to reach the predetermined deposition position 18 longitudinally. Once the truck has reached this position (FIG. 8) the method continues with the deposition step 28 during which the control unit 14 controls the vertical positioning of the arms 4a, 4b relative to the shelving 16 in order to deposit the load 12 there in the deposition position 18.

During this step the control unit 14 controls the lowering of the load 12 above the shelving 16 until the load 12 comes into contact with a part of the shelving 16 intended to receive the load 12. The control unit 14 then continues lowering the arms 4a, 4b, inducing vertical relative movement between the arms 4a, 4b and the load 12, indicating that the latter is no longer in contact with the arms 4a, 4b and rests entirely on the shelving 16.

Alternatively, the method 20 could comprise an additional step for heightwise positioning of the fork carried out after the substep 23b of deactivating the contactless detection device 8 and before the forward movement step 25. During this additional step the heightwise positioning of the fork may be continuous, in other words without registering any stopping of the vertical movement since the step 22 of heightwise positioning of the fork.

In another particular embodiment, in the step 25 of forward movement of the truck the control unit 14 can limit the forward movement of the forklift truck from the approach position to a maximum value dist (FIG. 5) corresponding to the component measured along the axis X of the minimum distance between the detection device 8 and the distal side CD of the detection zone 11.

In the deposition method depicted the heightwise positioning step 22 is effected by raising the fork. Alternatively, the heightwise positioning step 22 could be effected by lowering the fork. In this case the first height Z1 is greater than the second height Z2.

1.-4. (canceled)

5. A method of transporting and depositing a load by means of an autonomous forklift truck, the truck comprising:
a lifting member comprising a fork mobile vertically and provided with at least one arm for lifting loads;
a drive system for moving the forklift truck;
a control unit able to control operation of the drive system to guide the forklift truck autonomously and able to control the vertical movement of the fork of the lifting member;
a detection device for contactless detection of an obstacle, the detection device being mobile conjointly with the lifting member and able to emit a light beam directed toward a front of the forklift truck and sweeping at least one predefined plane detection zone, the detection device being fixed to the lifting member so that the light beam passes above the transported load; and
a measuring device for determining a height of the fork of the lifting member relative to the ground,
wherein the control unit receives information representing the height of the fork relative to the ground coming from the measuring device and representing a presence or an absence of an obstacle in the predefined plane detection zone coming from the detection device and able to control the drive system and the vertical movement of the fork of the lifting member as a function of the information, and
the method comprising the following steps:
a step of positioning the forklift truck relative to a structure intended to support the load in an approach position relative to the structure;
when the forklift truck has reached the approach position, a step of heightwise positioning of the fork of the lifting member and a step of obstacle detection by the detection device in a control volume swept by the light beam;
a step of forward movement of the forklift truck relative to the structure to a deposition position if no obstacle has been detected in the control volume by the detection device during the step of obstacle detection; and
a step of depositing the load on the structure at the deposition position.

6. The method according to claim 5, wherein the obstacle detection step comprises:
a substep of activation of the detection device when the fork of the lifting member has reached a predetermined first height Z1 relative to the ground during heightwise positioning of the fork; and
a substep of deactivation of the detection device when the fork of the lifting member has reached a second height Z2 relative to the ground that is different from the predetermined first height Z1.

7. The method according to claim 5 further comprising a step of controlling rectilinear movement of the forklift truck to the deposition position during the forward movement step.

8. The method according to claim 7, wherein the step of depositing the load on the structure in the deposition position is carried out if the controlled movement of the forklift truck is purely rectilinear or substantially rectilinear.
